(19) United States
(12) Patent Application Publication
(10) Pub. No.: US 2009/0244041 A1
(43) Pub. Date: Oct. 1, 2009

(54) LIQUID CRYSTAL DISPLAYS

(76) Inventor: Weon-Jun Choe, Seoul (KR)

Correspondence Address: Haynes and Boone, LLP;IP Section, 2323 Victory Avenue, SUITE 700, Dallas, TX, 75219, US

(21) Appl. No.: 12/265,928

(22) Filed: Nov. 6, 2008

(30) Foreign Application Priority Data
Mar. 28, 2008 (KR) 10-2008-0029089

(51) Int. Cl. G09G 5/00; G09G 3/36

(52) U.S. Cl. 345/211; 345/90

(57) ABSTRACT

A liquid crystal display device includes: first gate lines for transferring first gate signals; second gate lines for transferring second gate signals; first data lines for transferring normal data voltages, the first data lines running across the first and second gate lines; and pixels connected with the first and second gate lines and the first data lines. Each pixel includes: a liquid crystal capacitor, a first switching element having a control terminal connected with a respective one of the first gate lines, an input terminal connected with a respective one of the first data lines, and an output terminal connected with the liquid crystal capacitor, and a second switching element having a control terminal connected with a respective one of the second gate lines, an input terminal insulated from the first data line, and an output terminal connected with the liquid crystal capacitor. Other embodiments are also provided.

### CROSS-REFERENCE TO RELATED APPLICATION

This application claims priority to and the benefit of South Korean Patent Application No. 10-2008-0029089 filed in the Korean Intellectual Property Office on Mar. 28, 2008, the entire contents of which are incorporated herein by reference.

### BACKGROUND

(a) Field of the Invention

The present invention relates to liquid crystal displays.

(b) Description of the Related Art

Hold-type flat panel displays such as liquid crystal displays and the like display a stationary image during a certain time period, for example during a single frame time, regardless of whether the image is still or moving. For example, a continuously moving object can be displayed as stationary in each frame, at different positions in different frames. Because the LCD is able to maintain a residual image for longer than a frame, the object is visually perceived as if continuously moving although it is discretely displayed.

However, when viewing a moving object, the user's eyes continuously move along the object's expected path, colliding with the discrete displaying scheme, so image blurring phenomenon occurs. For example, suppose that the display device displays the object at a position (A) during a first frame and at a position (B) during a second frame. During the first frame, the user's eyes move along an expected movement path of the object from the position (A) to the position (B). However, the object is not displayed at intermediate positions between the positions (A) and (B). Consequently, the luminance recognized by the user during the first frame corresponds to a value obtained by integrating the luminance of the pixels in the path between the positions (A) and (B), namely, a value obtained by appropriately averaging the luminance of the object and that of the background, resulting in that the object is seen as blurred.

In a hold-type display device, the blurring degree of the image of the object is proportional to the time during which the object is displayed in a fixed position, so an impulse driving method has been proposed in which an image is displayed for less than a frame and a black color is displayed during the rest of the frame. For example, in an LCD, in each horizontal period, part of the horizontal period may be reserved for the LCD applying normal data voltages representing an image, and another part of the horizontal period may be reserved for the LCD applying a black data voltage representing a black color. Alternatively, in each frame, part of the frame can be reserved for applying normal data voltages while another part of the frame can be reserved for simultaneously applying a black data voltage to a group of pixel rows.

However, in the former case, the normal data voltages and the black data voltage are each applied for a very short time insufficient to obtain desired luminance at the pixels. In the latter case, the normal image and the black color are displayed on different time scales, to cause a so-called horizontal line defect.

The above information disclosed in this Background section is only for enhancement of understanding of the background of the invention and therefore it may contain information that does not form prior art.

### SUMMARY

An exemplary embodiment of the present invention provides a liquid crystal display device comprising: a plurality of first gate lines for transferring first gate signals; a plurality of second gate lines for transferring second gate signals; a plurality of first data lines for transferring normal data voltages, the first data lines running across the first and second gate lines; and a plurality of pixels that are connected with the first and second gate lines and the first data lines, wherein each pixel comprises: a liquid crystal capacitor, a first switching element having a control terminal connected with a respective one of the first gate lines, an input terminal connected with a respective one of the first data lines, and an output terminal connected with the liquid crystal capacitor, and a second switching element having a control terminal connected with a respective one of the second gate lines, an input terminal insulated from the first data line, and an output terminal connected with the liquid crystal capacitor.

In some embodiments, the LCD device further comprises a plurality of second data lines that are connected with the input terminals of the second switching elements for transferring black data voltages.

In some embodiments, in at least a subset of said pixels which subset comprises a plurality of pixels, the input terminal of the second switching element of each pixel and the liquid crystal capacitor of a corresponding adjacent pixel are connected to each other.

In some embodiments, in at least said subset of said pixels, each pixel's normal data voltage is to have an opposite polarity with respect to the corresponding adjacent pixel's normal data voltage.

In some embodiments, the input terminals of the second switching elements are connected to each other.

In some embodiments, the LCD device further comprises circuitry for alternately turning on the first and second switching elements of each pixel.

In some embodiments, the pixels are arranged in a matrix, and the circuitry is for turning on the first switching elements of one row of pixels while turning on the second switching elements of another row of pixels.

In some embodiments, the LCD device further comprises a gate driver comprising: a plurality of signal generators for generating gate drive signals, and a plurality of switches for selectively providing the gate drive signals to either the first gate lines or the second gate lines.

In some embodiments, the LCD device further comprises circuitry for determining normal data voltages for each pixel according to dynamic capacitance compensation (DCC) such that a normal data voltage at a pixel depends on a difference between a target luminance at the pixel and a luminance defined by a voltage that has been applied to the pixel during a previous frame.

In some embodiments, the LCD device further comprises circuitry for determining normal data voltages for each pixel according to dynamic capacitance compensation (DCC) such that a normal data voltage at a pixel depends on a difference between a target luminance at the pixel and a luminance value obtained at the pixel in a previous frame.

Some embodiments provide a liquid crystal display device comprising a plurality of pixels, wherein each pixel comprises: a liquid crystal capacitor for displaying an image in response to a voltage; a first switch for connecting the liquid crystal capacitor to associated first voltages provided for displaying, at the pixel, images corresponding to the associated first voltages; and a second switch for connecting the liquid crystal capacitor to associated second voltages provided for displaying, at the pixel, black colors corresponding to the associated second voltages, wherein the liquid crystal display device further comprises circuitry for controlling the first and second switches to cause each pixel to display an image based on an associated first voltage during an associated first interval of time and to display a black color based on an associated second voltage during an associated second interval of time.

In some embodiments, the circuitry is operable to provide an operation mode in which a first interval of one pixel and a second interval of another pixel start simultaneously and end simultaneously.

In some embodiments, the pixels form a plurality of pixel rows, and in said operation mode, for each pixel row, the first intervals of the pixels belonging to the pixel row coincide and the second intervals of the pixels belonging to the pixel row also coincide, wherein in said operation mode the first intervals of the pixels belonging to different pixel rows do not coincide and the second intervals of the pixels belonging to different pixel rows also do not coincide, and a first interval of a pixel belonging to any one pixel row corresponds to a second interval of a pixel belonging to a different pixel row.

In some embodiments, in said operation mode, for each two adjacent pixel rows, a turn-on interval of the first switches in one of the two adjacent pixel rows substantially immediately follows a turn-on interval of the first switches in the other one of the two adjacent pixel rows, and a turn-on interval of the second switches in one of the two adjacent pixel rows substantially immediately follows a turn-on interval of the second switches in the other one of the two adjacent pixel rows.

In some embodiments, in said operation mode, for each pixel, a length of a turn-on interval of the pixel's first switch and a length of a turn-on interval of the pixel's second switch are substantially the same.

In some embodiments, the circuitry is operable to obtain the first voltages based on image information received by the device.

In some embodiments, the circuitry is operable to obtain the second voltages by sharing electric charge between adjacent pixels.

In some embodiments, electric charge is from the adjacent pixels having opposite voltage polarities.

Some embodiments further comprise a data driver that supplies the first and second voltages.

Some embodiments provide a method for driving a liquid crystal display device, the method comprising: applying a normal data voltage to a liquid crystal capacitor of a first pixel during a first interval; applying a voltage indicating a black color to a liquid crystal capacitor of a second pixel during the first interval; applying a voltage indicating a black color to the liquid crystal capacitor of the first pixel during a second interval; and applying a normal data voltage to the liquid crystal capacitor of the second pixel during the second interval.

### BRIEF DESCRIPTION OF THE DRAWINGS

FIG. 1 is a schematic block diagram of a liquid crystal display (LCD) according to one exemplary embodiment of the present invention.

FIG. 2 is an equivalent circuit diagram of a pixel of the LCD in FIG. 1.

FIG. 3 is a schematic block diagram of an LCD according to another exemplary embodiment of the present invention.

FIGS. 4 and 5 are equivalent circuit diagrams of a pixel of the LCD in FIG. 3.

FIG. 6 is a schematic view of a gate driver according to one exemplary embodiment of the present invention.

FIG. 7 shows waveforms of drive signals of the LCD according to one exemplary embodiment of the present invention.

FIG. 8 shows waveforms of drive signals of the LCD according to another exemplary embodiment of the present invention.

FIG. 9 is a graph showing luminance of pixels in the LCD according to one exemplary embodiment of the present invention.

### DESCRIPTION OF REFERENCE NUMERALS INDICATING PRIMARY ELEMENTS IN THE DRAWINGS

| | |
|---|---|
| 3: liquid crystal layer | 100: lower panel |
| 191: pixel electrode | 200: upper panel |
| 230: color filter | 270: common electrode |
| 300: liquid crystal panel assembly | 400: gate driver |
| 500: data driver | 600: signal controller |
| 800: gray voltage generator | BF₁-BFₙ: buffer |
| Clc: liquid crystal capacitor | Cst: storage capacitor |
| CONT1: gate control signal | CONT2: data control signal |
| Din: input video signal | Dout: output video signal |
| DL, D₁-Dₘ: data line | |
| DN, DN₁-DNₘ: first data lines DB | |
| DB, DB₁-DBₘ: second data lines | |
| GN, GN₁-GNₙ: first gate lines | |
| GB, GB₁-GBₙ: second gate lines | |
| gN₁-gNₙ: first gate signals | gB₁-gBₙ: second gate signals |
| ICON: input control signal | PX: pixel |
| QN: first switching elements | |
| QB: second switching elements | |
| SE₁-SEₙ: select signals | SG₁-SGₙ: signal generators |
| SL: charge sharing line | STV: scan start signals |
| SW₁-SWₙ: switches | Vcom: common voltage |
| Voff: gate-off voltage | Von: gate-on voltage |
| Vpi, Vpᵢ₊₁: pixel voltages | |

### DETAILED DESCRIPTION OF SOME EMBODIMENTS

Some embodiments of the present invention will now be described with reference to the accompanying drawings. These embodiments illustrate but do not limit the present invention. The invention is defined by the appended claims.

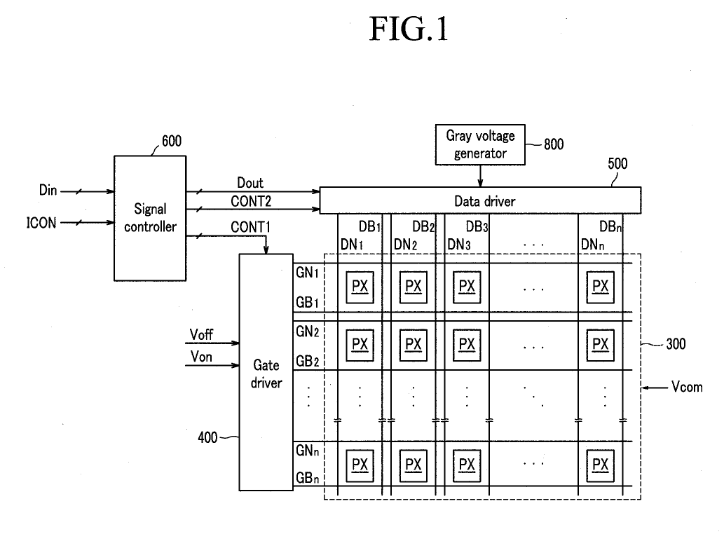

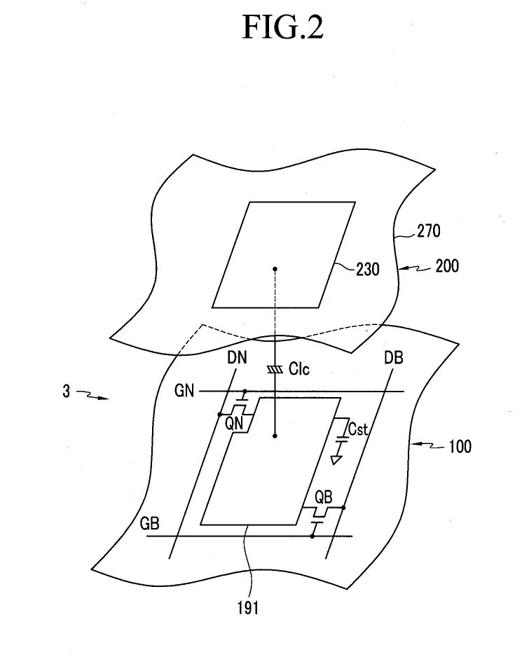

Liquid crystal displays (LCDs) according to some exemplary embodiments of the present invention are illustrated in FIGS. 1 to 6. FIG. 1 is a schematic block diagram of a liquid crystal display (LCD) according to one exemplary embodiment of the present invention, and FIG. 2 is a structural and circuit diagram of a pixel of the LCD in FIG. 1.

This LCD includes a liquid crystal panel assembly 300, a gate driver 400, a data driver 500, a gray voltage generator 800, and a signal controller 600. As shown in FIG. 1, the display panel assembly 300 includes a plurality of signal lines GN₁-GNₙ, GB₁-GBₙ, DN₁-DNₘ, and DB₁-DBₘ, and a plurality of pixels (PXs) connected with the signal lines and arranged substantially in a matrix. As shown in FIG. 2, the liquid crystal panel assembly 300 includes lower and upper display panels 100 and 200 and a liquid crystal layer 3 interposed therebetween.

The signal lines GN₁-GNₙ (“first gate lines”) transfer “first” gate signals. The signal lines GB₁-GBₙ (“second gate lines”) transfer “second” gate signals. The signal lines DN₁-DNₘ (“first data lines”) transfer normal data voltages. The signal lines DB₁-DBₘ (“second data lines”) transfer “black” data voltages. The first and second gate lines GN₁-GNₙ and GB₁-GBₙ extend substantially in the row direction in parallel to each other, and the first and second data lines DN₁-DNₘ and DB₁-DBₘ extend substantially in the column direction in parallel to each other.

Each pixel includes a first switching element QN, a second switching element QB, a liquid crystal capacitor Clc, and a storage capacitor Cst. The storage capacitor Cst is omitted in some embodiments.

The first and second switching elements QN and QB are three-terminal elements such as thin film transistors, etc., provided in the lower panel 100. Each first switching element QN has a control terminal connected to the corresponding first gate line GN (i.e. one of GN₁-GNₙ), an input terminal connected to the corresponding first data line DN (i.e. one of DN₁-DNₘ), and an output terminal connected to the corresponding liquid crystal capacitor Clc and storage capacitor Cst. Each second switching element QB has a control terminal connected to the corresponding second gate line GB (i.e. one of GB₁-GBₙ), an input terminal connected to the corresponding second data line DB (i.e. one of DB₁-DBₘ), and an output terminal connected to the corresponding liquid crystal capacitor Clc and the storage capacitor Cst. Thus, when the first switching element QN is turned on, the liquid crystal capacitor Clc receives a normal data voltage, and when the second switching element QB is turned on, the liquid crystal capacitor Clc receives a black data voltage.

The liquid crystal capacitor Clc has one plate provided by the corresponding pixel electrode 191 in the lower panel 100, the other plate provided by a common electrode 270 in the upper panel 200, and capacitor dielectric provided by the liquid crystal layer 3 and located between the electrodes 191 and 270. The pixel electrode 191 is connected with the switching elements QN and QB. The common electrode 270 extends over the entire surface of the upper panel 200 and receives a common voltage Vcom. Alternatively, the common electrode 270 may be located on the lower panel 100, and in this case, at least one of the two electrodes 191 and 270 in each pixel may be shaped as one or more lines or bars.

In each pixel, the storage capacitor Cst is an auxiliary to the liquid crystal capacitor Clc and is formed in the lower display panel 100 as a separate signal line overlapping with the pixel electrode 191 with an insulator interposed therebetween. The signal line receives a predetermined voltage, for example the common voltage Vcom. Alternatively, the storage capacitor Cst may be formed by an overlap of the pixel electrode 191 with at least one of the gate lines GBᵢ₋₁ and GNᵢ₋₁, with an insulator provided between the gate line and the pixel electrode.

In order to display color images, the pixels PX may be equipped to display different primary colors. In some embodiments, each pixel PX is permanently associated with one of primary colors to always display the associated color (spatial division). In other embodiments, each pixel PX sequentially displays different primary colors (time division). A desired color is provided as the spatial or temporal sum of the primary colors. The primary colors may include, for example, red, green, and blue colors. FIG. 2 shows an example of the spatial division, in which each pixel PX includes a color filter 230 representing the associated primary color. The color filters 230 may be located in the upper panel 200 as in FIG. 2 or in other locations above or below the pixel electrode 191.

The liquid crystal panel assembly 300 includes at least one polarizer (not shown).

Referring again to FIG. 1, the gray voltage generator 800 generates the “gray” voltages for all the possible luminance levels which can be displayed at the pixels PXs, or alternatively generates a subset of the gray voltages (this subset is called “reference gray voltages” hereinafter). The reference gray voltages may include positive or negative voltages relative to the common voltage Vcom.

The data driver 500 is connected with the first and second data lines DN₁-DNₘ, DB₁-DBₘ of the liquid crystal panel assembly 300. If the gray voltage generator 800 generates all the possible gray voltages, then the data driver 500 selects some of the gray voltages generated by the gray voltage generator 800 and applies the selected voltages as data voltages to the respective data lines DN₁-DNₘ and DB₁-DBₘ. If the gray voltage generator 800 generates only the subset of reference gray voltages, then the data driver 500 divides the reference gray voltages to generate desired data voltages.

The gate driver 400 is connected with the first and second gate lines GN₁-GNₙ and GB₁-GBₙ of the display panel assembly 300. The gate driver 400 generates gate driver signals each of which alternates between a gate-on voltage Von for turning on the respective first or second switching elements QN, QB and a gate-off voltage (Voff) for turning off the respective first or second switching elements QN, QB. The gate driver signals are applied to the respective gate lines GN₁-GNₙ and GB₁-GBₙ.

The signal controller 600 controls the gate driver 400, the data driver 500, and other circuits of the liquid crystal display.

The circuits 400, 500, 600, and 800 may be fabricated as one or more integrated chips (ICs) and may be directly mounted on the liquid crystal panel assembly 300, or may be mounted on a flexible printed circuit film (not shown) attached to the liquid crystal panel assembly 300 as a tape carrier package (TCP), or may be mounted on a separate printed circuit board (PCB) (not shown). Alternatively, the circuits 400, 500, 600, and 800 may be integrated together with the signal lines GN₁-GNₙ, GB₁-GBₙ, DN₁-DNₘ, and DB₁-DBₘ and the TFT switching elements QN and QB on the liquid crystal panel assembly 300. The circuits 400, 500, 600, and 800 may be integrated as a single chip or multiple chips with or without other, discrete circuit elements.

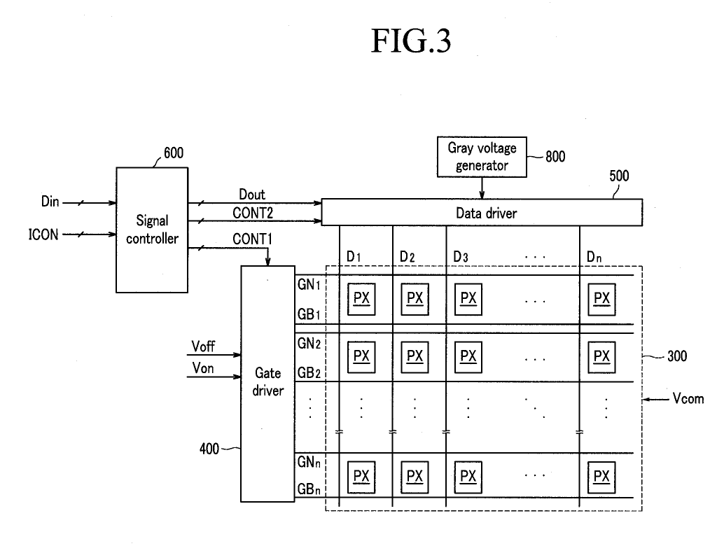

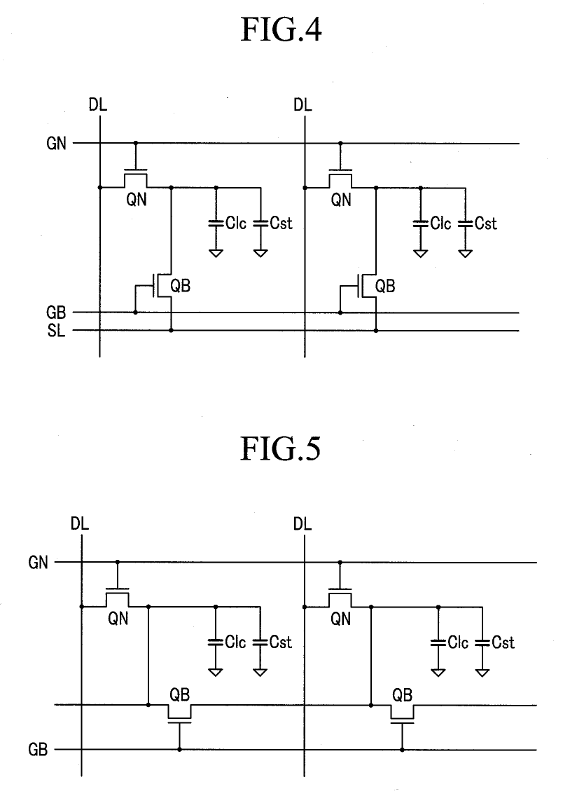

FIGS. 3-5 illustrate LCDs according to other exemplary embodiments of the present invention. FIG. 3 is a schematic block diagram of such LCDs, and FIGS. 4 and 5 are circuit diagrams of possible pixel implementations for the LCD of FIG. 3.

Like the LCD of FIG. 1, the LCD of FIG. 3 includes a liquid crystal panel assembly 300, a gate driver 400, a data driver 500, a gray voltage generator 800, and a signal controller 600. The liquid crystal display panel assembly 300 includes gate lines GN₁-GNₙ and GB₁-GBₙ, data lines D₁-Dₘ, and pixels PX. Unlike the LCD of FIGS. 1 and 2, the LCD of FIG. 3 does not have data lines for transferring black data voltages but only has the data lines D₁-Dₘ for transferring normal data voltages.

With reference to FIGS. 4 and 5, each pixel PX includes a first switching element QN, a second switching element QB, a liquid crystal capacitor Clc, and a storage capacitor Cst. Like in FIG. 2, the first switching element QN of FIGS. 4 and 5 has a control terminal connected with the corresponding first gate line GN (i.e. one of GN₁-GNₙ), an input terminal connected with the corresponding data line DL (i.e. one of D₁-Dₘ), and an output terminal connected with the liquid crystal capacitor Clc and the storage capacitor Cst. The second switching element QB has a control terminal connected with the second gate line GB (i.e. one of GB₁-GBₙ) and an output terminal connected with the liquid crystal capacitor Clc and the storage capacitor Cst.

Unlike in the embodiment of FIG. 2, in the embodiment of FIG. 4 the input terminals of the second switching elements QB are connected to a common charge sharing line SL. The charge sharing line SL may float, or may receive a constant voltage such as the common voltage Vcom or the like.

In the embodiment of FIG. 5, in each pixel PX in each row and column except possibly for the first or last column, the input terminal of each second switching element QB is connected with the output terminals of the first and second switching elements QN and QB of an adjacent pixel PX in the same row.

In the embodiments of FIGS. 4 and 5, when a second gate line GB is at the gate-on voltage Von, the second switching elements QB are turned on in the corresponding row to equalize the voltages across all the liquid crystal capacitors Clc in that row.

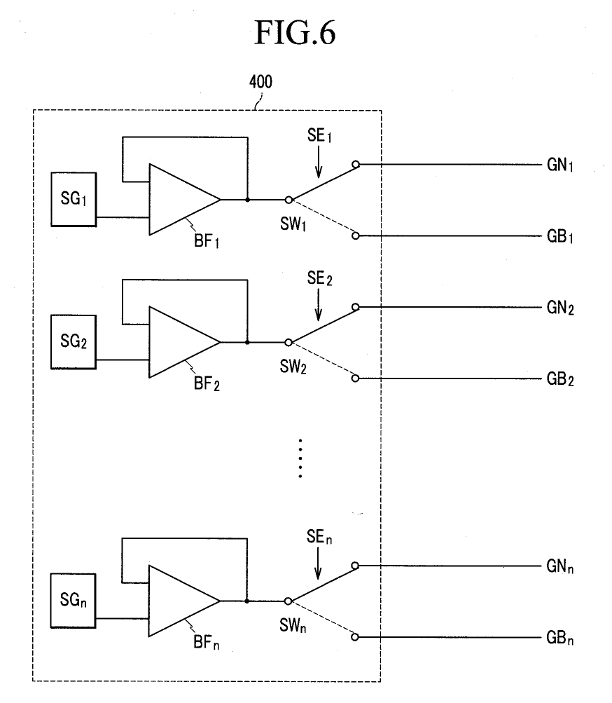

FIG. 6 is a schematic view of the gate driver 400 according to one exemplary embodiment of the present invention. The gate driver 400 includes signal generators SG₁-SGₙ, buffers BF₁-BFₙ, and switches SW₁-SWₙ.

The signal generators SG₁-SGₙ generate respective gate drive signals, and the buffers BF₁-BFₙ stabilize and maintain the respective gate drive signals.

Each switch SWᵢ (i=1, . . . , n) is connected to the respective buffer BFᵢ. Each switch SWᵢ connects the output of the respective buffer BFᵢ to the respective first gate line GNᵢ or the respective second gate line GBᵢ based on the respective select signal SEᵢ. The switches SW₁-SWₙ may each be implemented as a 2:1 multiplexer.

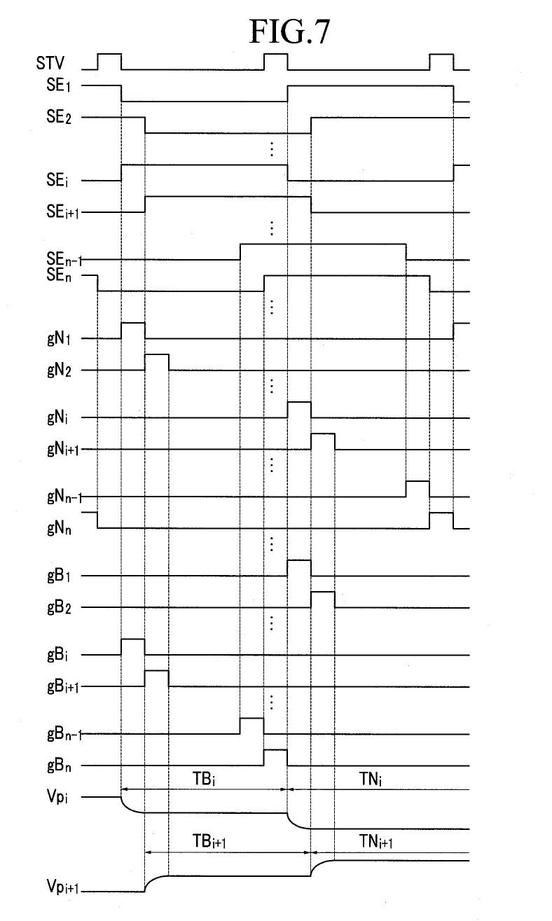

An LCD constructed as described above in connection with FIGS. 1 to 6 can be operated, for example, as illustrated in the drive signals' timing diagrams shown in FIG. 7. This operation is as follows.

An external graphics controller (not shown) provides to the signal controller 600 an input video signal Din and an input control signal ICON for controlling display of the input video signal. The input video signal Din includes luminance information for display at each pixel PX in displaying the image. The luminance can be any one of a predetermined number of grays. The number of grays can be, for example, 1024 (=2¹⁰), 256 (=2⁸), or 64 (=2⁶). The input control signal ICON may include, for example, a vertical synchronization signal, a horizontal synchronization signal, a main clock signal, a data enable signal, and the like.

The signal controller 600 processes the input video signal Din based on operating parameters of the display panel 300 and on the input control signal ICON, to convert the input video signal Din to an output video signal Dout and generate a gate control signal CONT1, a data control signal CONT2, etc. Then, the signal controller 600 transmits the gate control signal CONT1 to gate driver 400, and the data control signal CONT2 and the output video signal Dout to the data driver 500.

The gate control signal CONT1 includes a scan start signal STV indicating the start of scanning, and includes at least one clock signal controlling an output period of the gate-on voltage Von, and also includes the select signals SE₁-SEₙ controlling the switches SW₁-SWₙ. The gate control signal CONT1 may further include an output enable signal for limiting the duration of the gate-on voltage Von.

The data control signal CONT2 includes a horizontal synchronization start signal indicating the start of driving the digital output video signal Dout for one row of pixels PX, a load signal indicating application of analog data voltages to the data lines DN₁-DNₘ and DB₁-DBₘ or data lines D₁-Dₘ, and a data clock signal. The data control signal CONT2 may further include an inversion signal for inverting the polarity of the data voltages with respect to the common voltage Vcom (“the polarity of the data voltage with respect to the common voltage” will be referred to as “the polarity of the data voltage” hereinafter).

The signal generators SG₁-SGₙ of the gate driver 400 generate gate drive signals according to the scan start signal STV or the like received from the signal controller 600 and output the generated gate drive signals to the buffers BF₁-BFₙ. Each switch SWᵢ (i=1, . . . , n) connects the respective buffer BFᵢ to either the first gate line GNᵢ or the second gate line GBᵢ based on the select signal SEᵢ received from the signal controller 600. In the example of FIG. 7, i=n/2.

Each select signal SEᵢ (i=1, . . . , n) may be a high voltage or a low voltage. In the embodiment of FIG. 7, if the select signal SEᵢ is the low voltage, then the output of buffer BFᵢ is connected to the first gate line GNᵢ. If the select signal SEᵢ is the high, then the output of buffer BFᵢ is connected to the second gate line GBᵢ. In some other embodiments, the opposite operation takes place. Each select signal SEᵢ is held for about one half of a frame and then inverted. The inversion times of the select signals SEᵢ, SEᵢ₊₁ for the adjacent rows of pixels differ by about one horizontal period.

In FIG. 7, the voltages on the first gate lines GN₁-GNₙ are denoted respectively as gN₁-gNₙ. These voltages are referred to as “first gate signals” below. The voltages on the second gate lines GB₁-GBₙ are denoted respectively as gB₁-gBₙ. These voltages are referred to as “second gate signals” below. Each gate drive signal becomes the gate-on voltage Von once in every half frame. Therefore, because the select signals SE₁-SEₙ are inverted once in every half frame, the first gate signals gN₁-gNₙ and the second gate signals gB₁-gBₙ each become the gate-on voltages Von once in every frame. In each pair of the first and second gate signals gNᵢ, gBᵢ (i=1, . . . , n), the Von pulses are spaced by a half frame from each other. Thus, the first switching element QN and the second switching element QB of each pixel PX are alternately turned on with a difference of about a half frame.

Each Von pulse of each of the first and second gate signals gN₁-gNₙ and gB₁-gBₙ lasts for one horizontal period, and accordingly one first gate signal gN₁-gNₙ and one second gate signal gB₁-gBₙ are simultaneously driven to the gate-on voltage level. Thus, a first switching element QN and a second switching element QB of two different pixels PX in different rows are simultaneously turned on.

The signal controller 600 controls the gate driver 400 to adjust the turn-on times of the first and second switching elements QN and QB and also controls the data driver 500 to apply to the pixels PX voltages coordinated with the turn-on periods of the two switching elements QN and QB. These operations depend on the particular embodiment. For example, in some embodiments of the LCD devices shown in FIGS. 1 and 2, the signal controller 600 generates a normal output video signal directly corresponding to the input video signal Din and also generates the black output video signal for displaying one or more “black” colors, and transmits the normal output video signal and the black output video signal as the output video signals Dout to the data driver 500. The data driver 500 receives the output video signals Dout from the signal controller 600, and selects the corresponding gray voltages to convert the output video signals into data voltages. The data driver 500 applies the normal data voltages (i.e. the gray voltages corresponding to the normal output video signal) to the first data lines DN₁-DNₘ, and applies the black data voltages (i.e. the gray voltages corresponding to the black output video signal) to the second data lines DB₁-DBₘ. Hence, the pixels whose first switching elements QN are turned on receive the normal data voltages via the first data lines DN₁-DNₘ, and the pixels having their second switching elements QB turned on receive the black data voltages via the second data lines DB₁-DBₘ.

The difference between a data voltage applied to a pixel PX and the common voltage Vcom is the pixel voltage and is the voltage across the pixel's liquid crystal capacitor Clc. This voltage acts on the liquid crystal molecules whose positions change depending on the magnitude of the pixel voltage so as to change the polarization of light passing through the liquid crystal layer 3. The change of polarization appears as a change in the light transmittance of the polarizer. In this way the pixels PX display luminances represented by the pixel voltages. Hence, the pixels receiving the normal data voltages display the image represented by the input video signal Din, while the pixels receiving the black data voltages display black colors.

A black color displayed by a pixel PX may or may not be the minimum luminance. For example, the black color's luminance may be a value determined with reference to results obtained by comparing video signals between adjacent frames. In this case, different pixels PX may display different black colors.

In the exemplary embodiments shown in FIGS. 3 to 5, the signal controller 600 and the data driver 500 may operate in a conventional manner. The signal controller 600 may generate only the normal output video signal and transmit it as the output video signal Dout to the data driver 500, and the data driver 500 may convert the output video signal Dout into data voltages in a conventional manner and apply the data voltages to the data lines D₁-Dₘ.

In these embodiments, the pixels whose first switching elements QN are turned on receive the normal data voltages to display the corresponding image. In FIG. 4, the pixels whose second switching elements QB are turned on are connected to a common charge sharing line SL. As described above, in some embodiments the charge sharing line SL may receive the common voltage Vcom. In such embodiments, the pixels have the minimum luminance.

In the embodiments of FIG. 5, the pixels whose second switching elements QB are turned on have their pixel electrodes connected together in each row. Let us consider the case of inversion driving in which the data voltages of adjacent pixels PX in each row have opposite polarities. In this case, before the switching elements QB are turned on in a row, one half of the pixels of that row are at positive polarity voltages and the other half of the pixels of that row are at negative polarity voltages. Therefore, when the switching elements QB are turned on to interconnect the pixel electrodes of that row, the charge sharing among the pixel electrodes results in a voltage substantially close to the common voltage Vcom. Thus, the pixels with the second switching elements QB turned on display a substantially black color.

In FIG. 7, the diagrams Vpᵢ and Vpᵢ₊₁ indicate respective voltages of an exemplary pixel electrode in the i-th and an exemplary pixel electrode in the (i+1)-th row (FIG. 7 shows the diagrams for i=n/2, but the diagrams are similar for the other i values). In these examples, Vpᵢ has negative polarity and Vpᵢ₊₁ has positive polarity. The voltages Vpᵢ and Vpᵢ₊₁ are normal voltages during the respective periods TNᵢ and TNᵢ₊₁ that start at the start of the Von pulses on the respective first gate lines GNᵢ and GNᵢ₊₁ and continue until before the start of the Von pulses on the respective second gate lines GBᵢ and GBᵢ₊. The pixel electrodes' voltages Vpᵢ and Vpᵢ₊₁ are at some median values (the voltage Vpᵢ is above its negative polarity value and the voltage Vpᵢ₊₁ is below its positive polarity value) during the respective periods TBᵢ and TBᵢ₊₁ that start at the start of the Von pulses on the respective second gate lines GBᵢ and GBᵢ₊₁ and continue until immediately before the Von pulses on the respective first gate lines GNᵢ and GNᵢ₊₁.

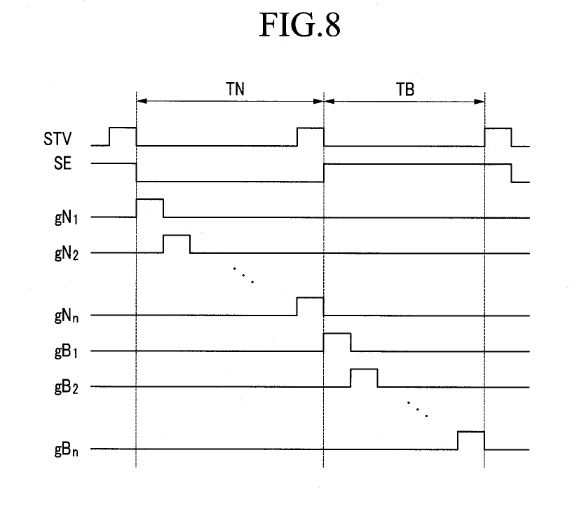

FIG. 8 illustrates LCD operation according to another exemplary embodiment of the present invention.

Unlike in FIG. 7, the embodiment of FIG. 8 provides a normal interval TN during which the gate-on voltage Von is sequentially applied to all of the first gate lines GN₁-GNₙ but not to any second gate line GB₁-GBₙ, and provides a black interval TB during which the gate-on voltage Von is sequentially applied to all of the second gate lines GB₁-GBₙ but not to any first gate line GN₁-GNₙ. Thus, only a row of the first switching elements QN or a row of the second switching elements QB can be turned on at any given time. One normal interval TN and one black interval TB can be provided in each frame or each pair of frames.

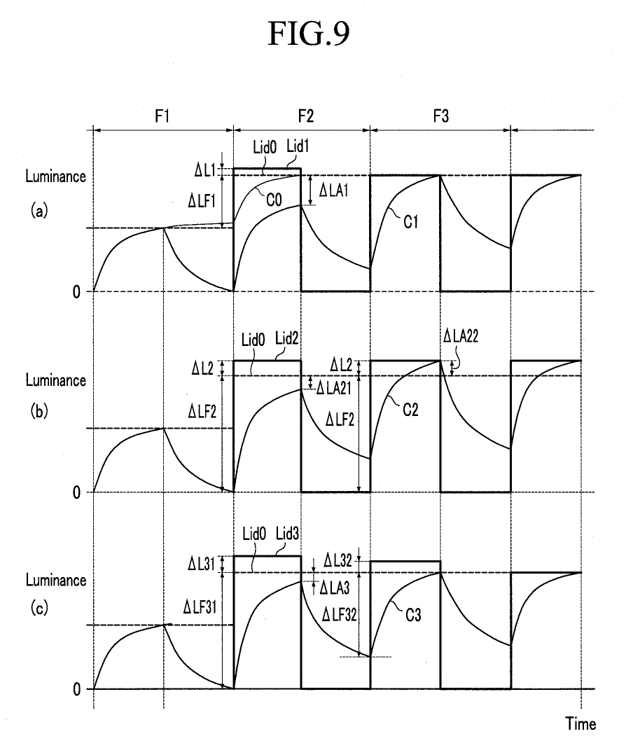

Exemplary driving methods according to some exemplary embodiments of the present invention will now be described in detail with reference to FIG. 9 which shows timing diagrams for some pertinent luminance values.

When a voltage is applied across a liquid crystal capacitor Clc, the liquid crystal molecules of the liquid crystal layer 3 move into a stable state corresponding to the voltage. Due to a slow response speed of the liquid crystal molecules, it takes time to reach the stable state. If the voltage across the liquid crystal capacitor Clc is held constant, the liquid crystal molecules keep moving until they reach the stable state, during which time the luminance (or light transmittance) changes. When the liquid crystal molecules reach the stable state, they stop moving, and the luminance becomes constant.

A pixel voltage in the stable state will be called a “target pixel voltage” herein. The luminance in the stable state will be called a “target luminance”. The target pixel voltage and the target luminance correspond to in a one-to-one relationship.

In each pixel PX, each switching element QN, QB is turned on for a time which may be too short for the liquid crystal molecules to reach the stable state. However, when the switching element QN or QB is turned off, the plates of the liquid crystal capacitor Clc remain at their respective voltages, and thus the liquid crystal molecules keep moving toward the stable state. As the liquid crystal molecules are moving, the permittivity of the liquid crystal layer 3 changes to change the capacitance of the liquid crystal capacitor Clc. When the switching elements QN and QB are off, one plate of the liquid crystal capacitor Clc floats, so the total charge stored in the liquid crystal capacitor Clc remains unchanged (ignoring the leakage current). Thus, the changing capacitance of the liquid crystal capacitor Clc causes a change in the voltage across the liquid crystal capacitor Clc, i.e. the pixel voltage.

Thus, if the data voltage applied to a pixel PX corresponds to the target pixel voltage (this data voltage is called “target data voltage” below) and is different from the immediately preceding data voltage applied to the pixel, then the actual pixel voltage will be different from the target pixel voltage, so the pixel luminance will differ from the target luminance. Further, the more the target luminance differs from the immediately preceding luminance of the pixel, the more the actual pixel voltage will differ from the target pixel voltage.

Thus, the data voltages applied to the pixels need to be adjusted up or down relative to the target data voltages, and one method for achieving this is through dynamic capacitance compensation (DCC).

The DCC is performed by the signal controller 600 or a separate video signal correcting unit. The DCC involves correcting the video signal for each pixel of a current frame based on the video signal for the same pixel for the immediately preceding frame. The desired corrections can be determined experimentally in advance for different possible values of the video signal, and the video signal can be corrected based on the experimental results. Generally, the correction may increase the difference between the current frame's video signal and the immediately preceding frame's video signal by a substantial amount. However, if for any pixel the difference between the uncorrected current video signal and the video signal for the immediately preceding frame is zero or small, the correction may be zero, i.e. the video signal's value may be the same as before the correction.

If the correction is not zero, then the data voltage applied to the pixel by the data driver 500 may be higher or lower than the target data voltage.

FIG. 9 illustrates pertinent luminances obtained in three different examples (a), (b), (c) in driving a pixel in three consecutive frames F1, F2, F3. In these diagrams, the dotted line Lid0 indicates the target luminance as defined by the normal input video signal. The luminance Lid0 is called “normal target luminance” below. The normal target luminance has the same values in all the three examples. The normal target luminance Lid0 increases by some value ΔLF1 from the first frame F1 to the second frame F2, and stays unchanged from the second frame F2 to the third frame F3.

In the “black” portion of the frame (which is the tail end of the frame when the black data signal is applied to the pixel), the target luminance corresponds to a black color. The black color is assumed to be zero luminance.

The DCC-corrected luminance is shown by the thick solid lines marked Lid1 in example (a), Lid2 in example (b), and Lid3 in example (c). In the “black” portion of each frame, the DCC-corrected luminance is assumed to be zero luminance (i.e. no correction is performed).

The actual luminances are shown as C1 in example (a), C2 in example (b), and C3 in example (c).

For the “normal” portion of each frame (i.e. when a normal data voltage is applied to the pixel), the DCC-corrected luminances Lid1, Lid2, Lid3 are calculated based on the difference between the normal target luminance Lid0 for that frame and some reference luminance for the immediately preceding frame. This difference is called “DCC reference luminance difference” below. In the example (a), the reference luminance is the normal target luminance Lid0. Thus, in the second frame F2, the DCC reference luminance difference is equal to ΔLF1. For the third frame F3, the DCC reference luminance difference is zero because there is no change in Lid0.

In the example (b), the reference luminance is the DCC-corrected luminance Lid2 at the end of the immediately preceding frame. Since the DCC-corrected luminance Lid2 is zero at the end of each frame (in the black portion of the frame), the DCC reference luminance difference in each frame is equal to the normal target luminance Lid0. The DCC reference luminance difference is shown as ΔLF2 for the second frame F2 and the third frame F3.

In the example (c), the reference luminance is the actual luminance C3. The DCC reference luminance difference is shown as ΔLF31 for the second frame F2 and ΔLF32 for the third frame F3.

For any given value of the DCC reference luminance difference, the DCC correction is the same in the examples (a), (b), and (c). Thus, the examples differ only in the choice of the reference luminance.

As stated above, in the example (a), the reference luminance is the normal target luminance Lid0. Thus, the DCC does not take the black data voltages into account, and hence in some embodiments the same DCC correction is performed as could be used without impulse driving, i.e. with normal data voltages applied for an entire frame. In the normal portion of the second frame F2, the DCC-corrected luminance Lid1 exceeds the normal target luminance Lid0 by some amount ΔL1. In the third frame F3, the DCC reference luminance difference is zero, so in the normal portion of the third frame F3 the DCC-corrected luminance Lid1 equals the normal target luminance Lid0.

If no impulse driving were used, i.e. the normal data voltage corresponding to the DCC-corrected luminance Lid1 were held constant for the entire frame, then the actual luminance could be as shown by the curve C0.

In the impulse driving case, the actual luminance is shown by the curve C1. Due to the black data voltages, the actual luminance C1 at the tail end of the first frame F1 is considerably lower than the no-impulse-driving luminance C0. Throughout the second frame F2, the actual luminance C1 is below the luminance C0, and the maximum value of C1 is behind the target luminance Lid0 by a large amount ΔLA1. The actual luminance C1 reaches the normal target luminance Lid0 only in the third frame F3.

In the example (b), the reference luminance is the DCC-corrected luminance Lid2 at the end of the immediately preceding frame, and the DCC reference luminance difference is equal to the normal target luminance Lid0, as explained above. The DCC reference luminance difference values are shown as ΔLF2 in the second and third frames F2 and F3; these values are much larger than the corresponding DCC reference luminance differences in example (a), i.e. than ΔLF1 and zero. Therefore, in the example (b), the values of DCC-corrected luminance Lid2 in the normal portions of the second and third frames F2, F3 are larger than the corresponding values of the DCC-corrected luminance Lid1 in the example (a). In the example (b), the difference between the DCC-corrected luminance Lid2 in the normal portion of the frame and the normal target luminance Lid0 is the same value ΔL2 in the second frame F2 and the third frame F3 since the normal target luminance Lid0 is the same value for these two frames. The value ΔL2 is higher than the similar value ΔL1 in the example (a), so the corresponding normal data voltage in the second frame F2 in the example (b) will be higher than in the example (a). As a result, although the actual luminance C2 in the example (b) is still behind the target luminance Lid0 in the second frame F2, the minimum difference ΔLA21 between the two luminance values in the normal portion of the second frame F2 can be lower than the similar value ΔLA1 in the example (a).

In the third frame F3 in the example (b), the DCC reference luminance difference is the same as in the second frame F2. Therefore, the normal data voltage in the third frame F3 will be the same as in the second frame F2. However, the actual luminance C2 in the third frame F3 can be higher than in the second frame F2. This is because the actual luminance C2 is higher at the end of the second frame F2 than at the end of the first frame F1. More particularly, the actual luminance C2 decreases to zero in the black portion of the first frame F1 but does not reach zero in the second frame F2. In this example, in the third frame F3, the maximum value of the actual luminance C2 exceeds the normal target luminance Lid0 by some amount ΔLA22. In the second frame F2, the maximum value of the actual luminance C2 is below the normal target luminance Lid0 by some amount ΔLA21.

In the example (c), the reference luminance is the actual luminance C3 at the end of the preceding frame as explained above. The DCC reference luminance difference for the second frame F2 is shown as ΔLF31. The value ΔL31 is the DCC correction for the normal portion of the second frame, i.e. the difference between the DCC-corrected luminance Lid3 in the normal portion of the frame and the normal target luminance Lid0. In this example, the actual luminance C3 becomes zero at the end of the first frame F1, and hence the DCC-corrected luminance Lid3 for the normal portion of the second frame F2 is the same as the DCC-corrected luminance Lid2 in the example (b) (i.e., ΔLF31=ΔLF2 and ΔL31=ΔL2). Therefore, in the second frame F2, the actual luminance C3 has the same values as the actual luminance C2 in the example (b), and the minimum difference ΔLA3 between the actual luminance C3 and the target luminance Lid0 can be the same as the value ΔLA21 in the example (b).

At the end of the second frame F2, the actual luminance C3 is positive in spite of the black data voltage, and therefore the DCC reference luminance difference ΔLF32 for the third frame F3 is smaller than the DCC reference luminance difference ΔLF31 for the second frame F2. Consequently, in the normal portion of the third frame F3, the DCC-corrected luminance Lid3 (and hence the normal data voltage) is lower than in the second frame F2. The DCC-corrected luminance Lid3 exceeds the normal target luminance Lid0 by some value ΔL32<ΔL31 in the normal portion of the third frame F3. The actual luminance C3 reaches the normal target luminance Lid0 in the third frame F3 and is lower than the actual luminance C2 in the example (b).

Suitable DCC correction values can be experimentally obtained for different combinations of values of the normal output video signal for the current frame and the immediately preceding frame and can be stored in a look-up table or in some other manner.

Thus, in some embodiments, horizontal line defects and/or possibly other image defects can be reduced when the impulse driving is performed in the LCD. Such benefits can be obtained with or without DCC.

The invention is not limited to the embodiments and advantages described above but includes other embodiments and variations as defined by the appended claims.

What is claimed is:

1. A liquid crystal display device comprising:
a plurality of first gate lines for transferring first gate signals;
a plurality of second gate lines for transferring second gate signals;
a plurality of first data lines for transferring normal data voltages, the first data lines running across the first and second gate lines; and
a plurality of pixels that are connected with the first and second gate lines and the first data lines,
wherein each pixel comprises:
a liquid crystal capacitor,
a first switching element having a control terminal connected with a respective one of the first gate lines, an input terminal connected with a respective one of the first data lines, and an output terminal connected with the liquid crystal capacitor, and
a second switching element having a control terminal connected with a respective one of the second gate lines, an input terminal insulated from the first data line, and an output terminal connected with the liquid crystal capacitor.

2. The device of claim 1, further comprising a plurality of second data lines that are connected with the input terminals of the second switching elements for transferring black data voltages.

3. The device of claim 1, wherein in at least a subset of said pixels which subset comprises a plurality of pixels, the input terminal of the second switching element of each pixel and the liquid crystal capacitor of a corresponding adjacent pixel are connected to each other.

4. The device of claim 3, wherein in at least said subset of said pixels, each pixel's normal data voltage is to have an opposite polarity with respect to the corresponding adjacent pixel's normal data voltage.

5. The device of claim 1, wherein the input terminals of the second switching elements are connected to each other.

6. The device of claim 1, further comprising circuitry for alternately turning on the first and second switching elements of each pixel.

7. The device of claim 6, wherein the pixels are arranged in a matrix, and the circuitry is for turning on the first switching elements of one row of pixels while turning on the second switching elements of another row of pixels.

8. The device of claim 7, further comprising a gate driver comprising:
a plurality of signal generators for generating gate drive signals, and
a plurality of switches for selectively providing the gate drive signals to either the first gate lines or the second gate lines.

9. The device of claim 1, further comprising circuitry for determining normal data voltages for each pixel according to dynamic capacitance compensation (DCC) such that a normal data voltage at a pixel depends on a difference between a target luminance at the pixel and a luminance defined by a voltage that has been applied to the pixel during a previous frame.

10. The device of claim 1, further comprising circuitry for determining normal data voltages for each pixel according to dynamic capacitance compensation (DCC) such that a normal data voltage at a pixel depends on a difference between a target luminance at the pixel and a luminance value obtained at the pixel in a previous frame.

11. A liquid crystal display device comprising a plurality of pixels,
wherein each pixel comprises:
a liquid crystal capacitor for displaying an image in response to a voltage;
a first switch for connecting the liquid crystal capacitor to associated first voltages provided for displaying, at the pixel, images corresponding to the associated first voltages; and
a second switch for connecting the liquid crystal capacitor to associated second voltages provided for displaying, at the pixel, black colors corresponding to the associated second voltages,
wherein the liquid crystal display device further comprises circuitry for controlling the first and second switches to cause each pixel to display an image based on an associated first voltage during an associated first interval of time and to display a black color based on an associated second voltage during an associated second interval of time.

12. The device of claim 11, wherein the circuitry is operable to provide an operation mode in which a first interval of one pixel and a second interval of another pixel start simultaneously and end simultaneously.

13. The device of claim 12, wherein the pixels form a plurality of pixel rows, and in said operation mode, for each pixel row, the first intervals of the pixels belonging to the pixel row coincide and the second intervals of the pixels belonging to the pixel row also coincide,
wherein in said operation mode the first intervals of the pixels belonging to different pixel rows do not coincide and the second intervals of the pixels belonging to different pixel rows also do not coincide, and a first interval of a pixel belonging to any one pixel row corresponds to a second interval of a pixel belonging to a different pixel row.

14. The device of claim 13, wherein in said operation mode, for each two adjacent pixel rows, a turn-on interval of the first switches in one of the two adjacent pixel rows substantially immediately follows a turn-on interval of the first switches in the other one of the two adjacent pixel rows, and a turn-on interval of the second switches in one of the two adjacent pixel rows substantially immediately follows a turn-on interval of the second switches in the other one of the two adjacent pixel rows.

15. The device of claim 13, wherein in said operation mode, for each pixel, a length of a turn-on interval of the pixel's first switch and a length of a turn-on interval of the pixel's second switch are substantially the same.

16. The device of claim 11, wherein the circuitry is operable to obtain the first voltages based on image information received by the device.

17. The device of claim 11, wherein the circuitry is operable to obtain the second voltages by sharing electric charge between adjacent pixels.

18. The device of claim 17, wherein electric charge is from the adjacent pixels having opposite voltage polarities.

19. The device of claim 16, further comprising
a data driver that supplies the first and second voltages.

20. A method for driving a liquid crystal display device, the method comprising:
applying a normal data voltage to a liquid crystal capacitor of a first pixel during a first interval;
applying a voltage indicating a black color to a liquid crystal capacitor of a second pixel during the first interval;
applying a voltage indicating a black color to the liquid crystal capacitor of the first pixel during a second interval; and
applying a normal data voltage to the liquid crystal capacitor of the second pixel during the second interval.
